(19) United States
(12) Patent Application Publication
(10) Pub. No.: US 2022/0415108 A1
(43) Pub. Date: Dec. 29, 2022

(54) INDICATION SYSTEM AND A METHOD FOR GENERATING AN INDICATION

(71) Applicant: KONE Corporation, Helsinki (FI)

(72) Inventors: Jussi Laurila, Helsinki (FI); Visa Rauta, Helsinki (FI)

(73) Assignee: KONE Corporation, Helsinki (FI)

(21) Appl. No.: 17/903,533

(22) Filed: Sep. 6, 2022

Related U.S. Application Data
(63) Continuation of application No. PCT/FI2020/050248, filed on Apr. 15, 2020.

(51) Int. Cl. G07C 9/29; G08B 5/36; G07C 9/25; B66B 1/46

(52) U.S. Cl. CPC G07C 9/29; G08B 5/36; G07C 9/25; B66B 1/468; B66B 5/0012

(57) ABSTRACT

The invention relates to an indication system for generating an indication. The system comprises: at least one indication device, at least one detection device configured to monitor at least one area inside a building to provide monitoring data, and a control unit. The control unit is configured to: detect based on the monitoring data obtained from the at least one detection device at least one predefined object with a specific need, and control the at least one indication device to generate a visual indication comprising guidance information to a gate device allocated for the detected at least one predefined object in response to the detection of the at least one predefined object. The invention relates also to a method for generating an indication.

### TECHNICAL FIELD

The invention concerns in general the technical field of visual indication. Especially the invention concerns systems for generating visual indication.

### BACKGROUND

Typically, gate devices, such as security gates, may comprise access control. The access control enables that only authorized users may have access through the gate device. The access control may be based on using keycards; tags; identification codes, such as personal identity number (PIN) code, ID number; and/or biometric technologies, such as fingerprint, facial recognition, iris recognition, retinal scan, voice recognition, etc.

Typically, two or more gate devices may be arranged next to each other. At least one of the gate devices may be wider that the other gate devices. The at least one wider gate device may be reserved for a specific use, e.g. for users moving with a wheelchair or a parcel. This reservation may typically be permanently marked causing a minor other use of the wider gate device when the special use is not required.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present an indication system and a method for generating an indication. Another objective of the invention is that the indication system and the method for generating an indication enables an on-demand indication of a gate device allocated for a special use.

The objectives of the invention are reached by an indication system and a method as defined by the respective independent claims.

According to a first aspect, an indication system for generating an indication is provided, wherein the system comprises: at least one indication device, at least one detection device configured to monitor at least one area inside a building to provide monitoring data, and a control unit configured to: detect based on the monitoring data obtained from the at least one detection device at least one predefined object with a specific need, and control the at least one indication device to generate a visual indication comprising guidance information to a gate device allocated for the detected at least one predefined object in response to the detection of the at least one predefined object.

The operation of the at least one detection device may be based on object recognition or pattern recognition.

The at least one indication device may comprise one or more displays on which the visual indication may displayed and/or one or more or projector devices configured to project the generated visual indication on a floor in a vicinity of the allocated gate device.

The monitored at least one area may comprise an area surrounding at least the allocated gate device on at least one side of the allocated gate device.

The object with the specific need may be a wheelchair, rolling walker, stroller, luggage, trolley, a parcel delivery, and/or a specific outfit.

The allocated gate device may have a widened passageway.

The allocated gate device may further be configured to: identify a user associated with the detected at least one predefined object, and allow access via the allocated gate device in response to identification of the user associated with the detected at least one predefined object.

Moreover, the identification may be based on a keycard, a tag, an identification code, and/or a biometric technology.

Alternatively or in addition, the allocated gate device may be configured to instruct an elevator control system to generate an elevator call to allocate an elevator car for said user associated with the detected at least one predefined object in response to identification of the user associated with the detected at least one predefined object.

The monitoring may comprise tracking movements of the detected object within at least one monitoring area.

According to a second aspect, a method for generating an indication is provided, wherein the method comprises: monitoring, by at least one detection device, at least one area inside a building to provide monitoring data; detecting, by a control unit, at least one predefined object with a specific need based on the monitoring data obtained from the at least one detection device; and controlling, by the control unit, at least one indication device to generate a visual indication comprising guidance information to a gate device allocated for the detected at least one object in response to the detection of the at least one predefined object.

The operation of the at least one detection device may be based on object recognition or pattern recognition.

The visual indication may be displayed on one or more displays and/or projected on a floor in a vicinity of the allocated gate device.

The monitored at least one area may comprise an area surrounding at least the allocated gate device on at least one side of the allocated gate device.

The object with the specific need may be a wheelchair, rolling walker, stroller, luggage, trolley, a parcel delivery, and/or a specific outfit.

The allocated gate device may have a widened passageway.

The method may further comprise: identifying a user associated with the detected at least one predefined object, and providing access via the allocated gate device in response to identification of the user associated with the detected at least one predefined object.

Moreover, the identification may be based on a keycard, a tag, an identification code, and/or biometric technologies.

Alternatively or in addition, the method may further comprise instructing an elevator control system to generate an elevator call to allocate an elevator car for said user associated with the detected at least one predefined object in response to identification of the user associated with the detected at least one predefined object.

The monitoring may comprise tracking movements and the detected object within at least one monitoring area.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example environment according to the invention, wherein different embodiments according to the invention may be implemented.

FIG. 2 illustrates schematically another example of the environment according to the invention, wherein different embodiments according to the invention may be implemented.

FIG. 3 illustrates schematically an example of a method according to the invention.

FIG. 4 illustrates schematically an example of components of a control unit according to the invention.

### DESCRIPTION OF THE EXEMPLIFYING EMBODIMENTS

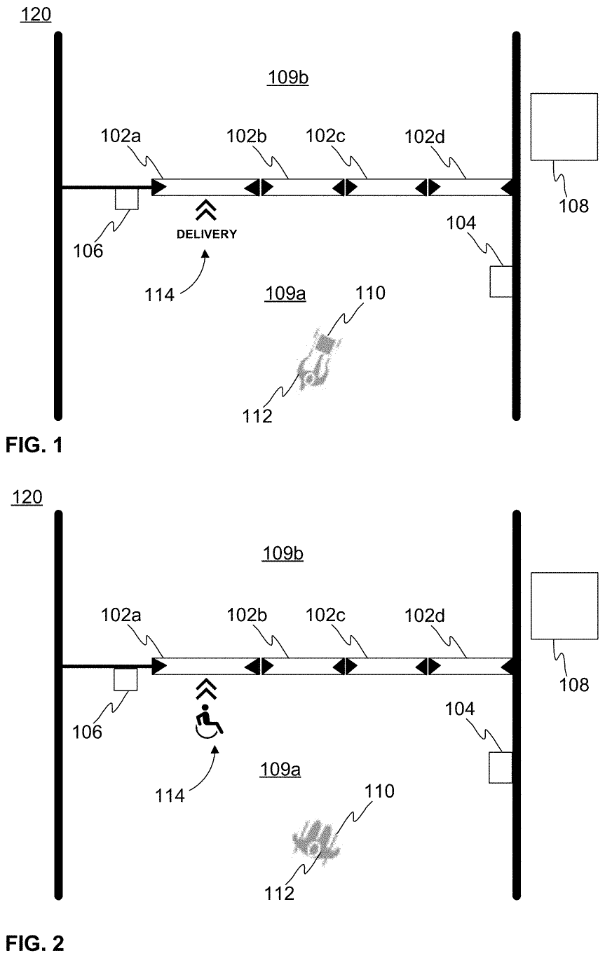

FIG. 1 illustrates schematically an example environment 120 according to the invention, wherein an indication system according to the invention may be implemented. The indication system according to the invention comprises at least one detection device 102 for providing monitoring data, at least one indication device 106, and a control unit 108. The example environment 120 of FIG. 1 comprises a plurality of gate devices 102a-102d arranged next to each other. The plurality of gate devices 102a-102d, e.g. security gates, may be provided with an access control operation. The access control operation enables that only authorized users may have access via the gate device 102a-102d. The access control operation may be based on using keycards; tags; identification codes, e.g. PIN code, ID number, barcodes, QR codes; and/or biometric technologies, e.g. fingerprint, facial recognition, iris recognition, retinal scan, voice recognition, etc. The example environment 120 according to the invention may further comprise, but is not limited to, an elevator behind the plurality of gate devices 102a-102d. Only the users that are identified as authorized users are allowed to access via the plurality of gate devices 102a-102d in order to be able to use the elevator. The plurality of gate devices 102a-102d may be communicatively coupled to an elevator control system of the elevator enabling a generation of an elevator call in response to identification of the authorized user.

The control unit 108 may be external entity or it may be implemented as a part of one or more other entities of the indication system. In the example of FIG. 1, the control unit 108 is an external entity. The external entity herein means an entity that locates separate from other entities of the indication system. The implementation of the control unit 108 may be done as a stand-alone entity or as a distributed computing environment between a plurality of stand-alone devices, such as a plurality of servers providing distributed computing resource. The control unit 108 may be configured to control the operations of the indication system. The control unit 108 may be communicatively coupled to at least one detection device 104, the at least one indication device 106, and any other entities of the indication system. The communication between the control unit 108 and the other entities of the indication system 100 may be based on one or more known communication technologies, either wired or wireless.

The at least one detection device 104 is configured to monitor at least one area 109a, 109b inside a building in which the indication system resides in order to provide the monitoring data. The monitored at least one area 109a, 109b may comprise an area surrounding at least an allocated gate device 102a, on at least one side of the allocated gate device 102a. The meaning of the allocated gate device 102a will be described later in this application. In addition, the monitored at least one area 109a, 109b may comprise an area surrounding the plurality of gate devices 102a-102b on at least one side of the plurality of gate devices 102a-102d. In other words, the monitored at least one are 109a, 109b may comprise a first area 109a on a first side of the plurality of gate devices 102a-102d and/or a second area 109b on a first side of the plurality of gate devices 102a-102d. According to an example, the monitored at least area 109a, 109b may comprise at least part of a lobby area of the building. In the example of FIG. 1 the indication system 100 comprises one detection device 104 arranged within the first area 109a so that the detection device 104 is capable to monitor the first area 109a. However, the invention is not limited to that and the indication system 100 may comprise any other number of detection devices 104 capable to monitor the first area 109a and/or the second area 109b.

The at least one detection device 104 may comprise at least one optical imaging device, e.g. at least one camera. The at least one detection device 104 may enable detection and/or tracking of an object 110 and/or a user 112 at a distance away from the at least one detection device 104. The distance may be e.g. between 0 to 10 meters from the at least one detection device 104 and preferably between 1 to 2 meters, 1 to 3 meters or 1 to 5 meters. The at least one detection device 104 may be arranged to a wall, a ceiling and/or to a separate support device arranged within the at least one monitored area. In the example of FIG. 1, the at least one detection device 104 is arranged to a wall of the monitored area 109a. According to an example embodiment of the invention, the operation of the at least one detection device 104 may be based on object recognition or pattern recognition.

The at least one detection device 104 is configured to provide the monitoring data to the control unit 108. The control unit 106 is configured to detect at least one predefined object 110 with a specific need. The detection of the at least one predefined object 110 with the specific need is based on the monitoring data obtained from the at least one detection device 104. The control unit 108 may utilize machine vision in the detection of the at least one predefined object 110 with the specific need. The object 110 with the specific need may be e.g. a wheelchair, rolling walker, stroller, luggage, trolley, a parcel delivery, and/or a specific outfit, e.g. a delivery company uniform. The specific need may comprise, but is not limited to, large size and/or slow speed.

The control unit 108 is configured to control the at least one indication device 104 to generate a visual indication 114 comprising guidance information to a gate device 102a allocated for the detected at least one predefined object 110 in response to the detection of the at least one predefined object 110. This enables an on-demand indication of the gate device 102a allocated for a special use, i.e. for the detected at least one predefined object 110 with the special need. The on-demand indication of the allocated gate device 102a enables releasing the allocated gate device 102a for other use when the special use is not required. This in turn improves the use capacity of the allocated gate device 102a.

According to an example, the visual indication 114 may be generated, e.g. projected, on the floor in front of the allocated gate device 102a as shown in the example FIG. 1. The guidance information may comprise e.g. text- and/or figure-based guidance information. In the example of FIG. 1 the control unit 108 detects based on the monitoring data obtained from the at least one detection device 104 a parcel delivery 110 and control the at least one indication device 104 to generate the visual indication 114 comprising an arrow figure with a text “delivery” on the floor in front of the allocated gate device 102a. FIG. 2 illustrates another example of the environment 120 according to the invention, wherein the indication system according to the invention may be implemented. The example of FIG. 2 is otherwise similar to the example of FIG. 1, but the predefined object 110 is a wheelchair. In the example of FIG. 2 the control unit 108 detects based on the monitoring data obtained from the at least one detection device 104 a user 112 moving with the wheelchair 110 and control the at least one indication device 104 to generate the visual indication 114 comprising an arrow figure with a figure of a wheelchair on the floor in front of the allocated gate device 102a.

The gate device 102a allocated for the specific use has a widened passageway. As shown in the example of FIG. 1, the allocated gate device 102a is wider, i.e. has wider passageway in the width direction, than the at least some of the other gate devices 102b-102d to enable easier access of the objects with the specific needs via the gate device 102a. If the plurality of gate devices 102a-102d comprises more than one gate device with the widened passageway for the specific use, one of the more than one gate devices may be selected as the allocated gate device 102a, e.g. based on traffic flow via the gate devices 102a-102d.

According to an example embodiment of the invention, the at least one indication device 106 may comprise one or more displays, on which the visual indication may be displayed. Alternatively or in addition, the at least one indication device 106 may comprise one or more projector devices configured to generate, e.g. project, the generated visual indication 114 on the floor in a vicinity of, i.e. in front of, the allocated gate device 102a as shown in the examples of FIGS. 1 and 2. In the examples of FIGS. 1 and 2 the indication system comprises one indication device 106 arranged within the monitoring area 109a, 109b, e.g. the lobby area, so that the indication device 106 is capable to generate the visual indication 114 on the floor in front of the allocated gate device 102a. However, the invention is not limited to that and the indication system 100 may comprise any other number of indication devices 106. The at least one indication device 106 may be arranged to a wall, a ceiling, a gate device 102a-102d, and/or to a separate support device arranged within the at least one monitored area 109a, 109b. In the example of FIG. 1, the at least one detection device 106 are arranged to a wall next to the allocated gate device 102a.

The visual indication 114 may be indicated during a predefined period of time. The predefined period of time may be such that the user 112 associated with the at least one predefined object 110 has time to see the visual indication, for example, but not limited to, the predefined period of time may be between 5 to 60 seconds. Alternatively, the visual indication 110 may be indicated until the detected at least one predefined object 110 has passed through the allocated gate device 102a.

According to an example embodiment of the invention, the monitoring may comprise tracking movements of the at least one predefined object 110 within the at least one monitoring area 109a, 109b. The tracking of the movement of the at least one predefined object 110 within the monitoring area 109a,109b may enable providing one or more further operations that requires locating of the at least one predefined object 110 and/or the user associated with the at least one predefined object 110 within the monitoring area 109a,109b.

According to an example embodiment of the invention, the allocated gate device 102a may further be provided with the access control operation to enable that only authorized users may have access via the gate device 102a. Only the users that are identified as authorized users are allowed to access via the allocated gate device 102a. Thus, the allocated gate device 102a may be configured to identify the user 112 associated with the detected at least one predefined object 110. The identification may be based on e.g. keycards; tags; identification codes, e.g. PIN code, ID number, barcodes, QR codes; and/or biometric technologies, e.g. fingerprint, facial recognition, iris recognition, retinal scan, voice recognition, etc. In response to identification of the user 112 associated with the detected at least one predefined object 110, the allocated gate device 102a may allow access via the allocated gate device 102a for the user 112 associated with the detected at least one predefined object 110.

The gate device 102a may comprise a barrier device, such as door panel(s), turnstile, boom or any other barrier device, for preventing access of unidentified users via the gate device 102a. Alternatively or in addition, the gate device 102a may comprise one or more alarm devices, e.g. visual and/or audio alarm devices, for generating an alarm, if an unidentified user attempts to pass through the gate device 102a. The gate device 102a may be by default at a state allowing an unrestricted access via the gate device 102a. In other words, the gate device 102a is maintained at the state allowing the unrestricted access via the gate device 102a. If the user is not identified, the gate device 102a, e.g. a control unit of the gate device 102a, may be configured to control the barrier device to prevent, i.e. restrict, the access via the gate device 102a, e.g. by closing the barrier device of the gate device 102a. Alternatively or in addition, the gate device 102a, e.g. a control unit of the gate device 102a, may be configured to control the one or more alarm devices to generate an alarm to indicate an access of an unauthorized user, if the user is not identified. Alternatively, the gate device 102a may be by default at a state preventing, i.e. restricting, the access of the users via the gate device 102a, i.e. the gate device 102a may be in a closed state. If the user is identified, the gate device 102a, e.g. a control unit of the gate device 102a, may be configured to control the barrier device to provide the access via the gate device 102a, e.g. by opening the barrier device of the gate device 102.

According to an example embodiment of the invention, the allocated gate device 102a may be configured to instruct the elevator control system of the elevator to generate an elevator call to allocate an elevator car for said user 112 associated with the detected object in response to identification of the user 112 associated with the detected at least one predefined object 110.

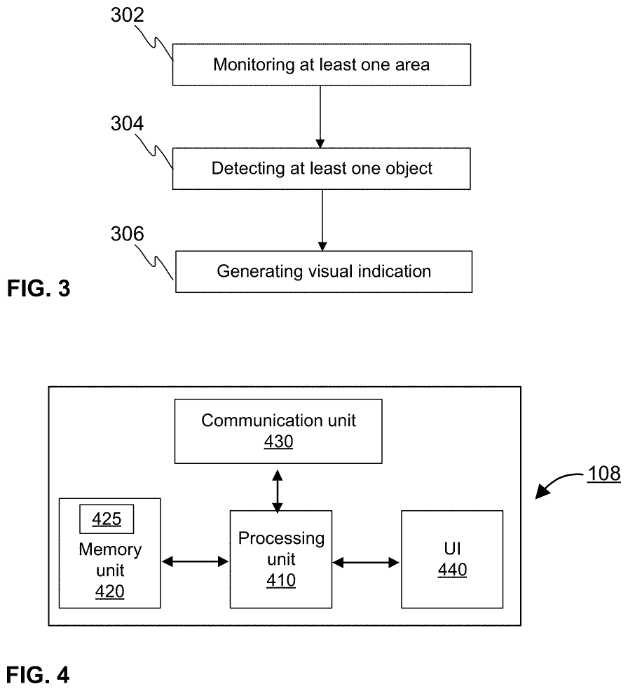

Next an example of the method according to the invention is described by referring to FIG. 3. FIG. 3 schematically illustrates the invention as a flow chart.

At a step 302, the at least one detection device 104 monitors at least one area inside the building in order to provide the monitoring data. The monitored at least one area 109a, 109b may comprise an area surrounding at least the allocated gate device 102a, on at least one side of the allocated gate device 102a. In addition, the monitored at least one area 109a, 109b may comprise an area surrounding the plurality of gate devices 102a-102b on at least one side of the plurality of gate devices 102a-102d. In other words, the monitored at least one are 109a, 109b may comprise a first area 109a on a first side of the plurality of gate devices 102a-102d and/or a second area 109b on a first side of the plurality of gate devices 102a-102d. According to an example, the monitored at least area may comprise at least part of a lobby area of the building. The at least one detection device 104 provides the monitoring data to the control unit 108.

At a step 304, the control unit 106 detects at least one predefined object 110 with a specific need. The detection of the at least one predefined object 110 with the specific need is based on the monitoring data obtained from the at least one detection device 104. The control unit 108 may utilize machine vision in the detection of the at least one predefined object 110 with the specific need. The object 110 with the specific need may be e.g. a wheelchair, rolling walker, stroller, luggage, trolley, a parcel delivery, and/or a specific outfit, e.g. a delivery company uniform. The specific need may comprise, but is not limited to, large size and/or slow speed.

At a step 306, the control unit 104 controls the at least one indication device 104 to generate a visual indication 114 comprising guidance information to a gate device 102a allocated for the detected at least one predefined object 110 in response to the detection of the at least one predefined object 110. This enables an on-demand indication of the gate device 102a allocated for a special use, i.e. for the detected at least one predefined object 110 with the special need. The on-demand indication of the allocated gate device 102a enables releasing the allocated gate device 102a for other use when the special use is not required. This in turn improves the use capacity of the allocated gate device 102a. The guidance information may comprise e.g. text- and/or figure-based guidance information.

The gate device 102a allocated for the specific use has a widened passageway. The allocated gate device 102a is wider, i.e. has wider passageway in the width direction, than the at least some of the other gate devices 102b-102d to enable easier access of the objects with the specific needs via the gate device 102a. If the plurality of gate devices 102a-102d comprises more than one gate device with the widened passageway for the specific use, one of the more than one gate devices may be selected as the allocated gate device 102a, e.g. based on traffic flow via the gate devices 102a-102d.

According to an example embodiment of the invention, the visual indication 114 may be displayed on one or more displays. Alternatively or in addition, the visual indication 114 may be generated, e.g. projected, by one or more or projector devices on the floor in a vicinity of, e.g. in front of, the allocated gate device 102a as shown in the examples of FIGS. 1 and 2.

The visual indication 114 may be indicated during a predefined period of time. The predefined period of time may be such that a user 112 associated with the at least one predefined object 110 has time to see the visual indication, for example, but not limited to, the predefined period of time may be between 5 to 60 seconds. Alternatively, the visual indication 110 may be indicated until the detected at least one predefined object 110 has passed through the allocated gate device 102a.

According to an example embodiment of the invention, the monitoring may comprise tracking movements of the at least one predefined object 110 within the at least one monitoring area 109a, 109b. The tracking of the movement of the at least one predefined object 110 within the monitoring area 109a,109b may enable providing one or more further operations that requires locating of the at least one predefined object 110 and/or the user associated with the at least one predefined object 110 within the monitoring area 109a,109b.

According to an example embodiment of the invention, the method may further comprise identifying, e.g. the gate device 102a, the user 112 associated with the detected at least one predefined object 110. This enables that only the users that are identified as authorized users are allowed to access via the allocated gate device 102a. The identification may be based on e.g. keycards; tags; identification codes, e.g. PIN code, ID number, barcodes, QR codes; and/or biometric technologies, e.g. fingerprint, facial recognition, iris recognition, retinal scan, voice recognition, etc. In response to identification of the user 112 associated with the detected at least one predefined object 110, the allocated gate device 102a may allow access via the allocated gate device 102a for the user 112 associated with the detected at least one predefined object 110.

According to an example embodiment of the invention, in response to identification of the user 112 associated with the detected at least one predefined object 110, the method may further comprise instructing the elevator control system of the elevator to generate an elevator call to allocate an elevator car for said user 112 associated with the detected object.

FIG. 4 schematically illustrates an example of components of the control unit 108 according to the invention. The control unit 108 may comprise a processing unit 410 comprising one or more processors, a memory unit 420 comprising one or more memories, a communication unit 430 comprising one or more communication devices, and possibly a user interface (UI) unit 450. The memory unit 420 may store portions of computer program code 425 and any other data, and the processing unit 410 may cause the control unit 108 to operate as described by executing at least some portions of the computer program code 425 stored in the memory unit 420. The communication unit 430 may be based on at least one known communication technologies, either wired or wireless, in order to exchange pieces of information as described earlier. The communication unit 430 provides an interface for communication with any external unit, such as the at least one indication device 106, the at least one detection device 104, database and/or any external entities or systems. The communication unit 430 may comprise one or more communication devices, e.g. radio transceiver, antenna, etc. The user interface 440 may comprise I/O devices, such as buttons, keyboard, touch screen, microphone, loudspeaker, display and so on, for receiving input and outputting information. The computer program 425 may be stored in a non-statutory tangible computer readable medium, e.g. an USB stick or a CD-ROM disc.

The specific examples provided in the description given above should not be construed as limiting the applicability and/or the interpretation of the appended claims. Lists and groups of examples provided in the description given above are not exhaustive unless otherwise explicitly stated.

1. An indication system for generating an indication, wherein the system comprises:
at least one indication device,
at least one detection device configured to monitor at least one area inside a building to provide monitoring data, and
a control unit configured to:
detect based on the monitoring data obtained from the at least one detection device at least one predefined object with a specific need, and
control the at least one indication device to generate a visual indication comprising guidance information to a gate device allocated for the detected at least one predefined object in response to the detection of the at least one predefined object.

2. The system according to claim 1, wherein the operation of the at least one detection device is based on object recognition or pattern recognition.

3. The system according to claim 1, wherein the at least one indication device comprises one or more displays on which the visual indication is displayed and/or one or more or projector devices configured to project the generated visual indication on a floor in a vicinity of the allocated gate device.

4. The system according to claim 1, wherein the monitored at least one area comprises an area surrounding at least the allocated gate device on at least one side of the allocated gate device.

5. The system according to claim 1, wherein the object with the specific need is a wheelchair, rolling walker, stroller, luggage, trolley, a parcel delivery, and/or a specific outfit.

6. The system according to claim 1, wherein the allocated gate device has a widened passageway.

7. The system according to claim 1, wherein the allocated gate device is further configured to:
identify a user associated with the detected at least one predefined object, and
allow access via the allocated gate device in response to identification of the user associated with the detected at least one predefined object.

8. The system according to claim 7, wherein the identification is based on a keycard, a tag, an identification code, and/or a biometric technology.

9. The system according to claim 7, wherein the allocated gate device is configured to instruct an elevator control system to generate an elevator call to allocate an elevator car for said user associated with the detected at least one predefined object in response to identification of the user associated with the detected at least one predefined object.

10. The system according to claim 1, wherein the monitoring comprises tracking movements of the detected object within at least one monitoring area.

11. A method for generating an indication, wherein the method comprising:
monitoring, by at least one detection device, at least one area inside a building to provide monitoring data,
detecting, by a control unit, at least one predefined object with a specific need based on the monitoring data obtained from the at least one detection device, and
controlling, by the control unit, at least one indication device to generate a visual indication comprising guidance information to a gate device allocated for the detected at least one object in response to the detection of the at least one predefined object.

12. The method according to claim 11, wherein the operation of the at least one detection device is based on object recognition or pattern recognition.

13. The method according to claim 11, wherein the visual indication is displayed on one or more displays and/or projected on a floor in a vicinity of the allocated gate device.

14. The method according to claim 11, wherein the monitored at least one area comprises an area surrounding at least the allocated gate device on at least one side of the allocated gate device.

15. The method according to claim 11, wherein the object with the specific need is a wheelchair, rolling walker, stroller, luggage, trolley, a parcel delivery, and/or a specific outfit.

16. The method according to claim 11, wherein the allocated gate device has a widened passageway.

17. The method according to claim 11, wherein method further comprises:
identifying a user associated with the detected at least one predefined object, and
providing access via the allocated gate device in response to identification of the user associated with the detected at least one predefined object.

18. The method according to claim 17, wherein the identification is based on a keycard, a tag, an identification code, and/or biometric technologies.

19. The method according to claim 17, wherein the method further comprises instructing an elevator control system to generate an elevator call to allocate an elevator car for said user associated with the detected at least one predefined object in response to identification of the user associated with the detected at least one predefined object.

20. The method according to claim 11, wherein the monitoring comprises tracking movements and the detected object within at least one monitoring area.
